(19) United States
(12) Patent Application Publication
(10) Pub. No.: US 2026/0358095 A1
(43) Pub. Date: Nov. 12, 2026

(54) AIMING DEVICES AND METHODS OF IMAGE CORRECTION

(71) Applicant: Asia Optical Co., Inc., Taichung (TW)

(72) Inventors: Ken-Chiakan Chang, Taichung (TW); Hung-Chi Chou, Taichung (TW); Tsung-Mou Tsai, Taichung (TW)

(21) Appl. No.: 19/663,435

(22) Filed: Apr. 30, 2026

(30) Foreign Application Priority Data
May 8, 2025 (TW) 114117320

(51) Int. Cl. F41G 3/06; F41G 3/08; G02B 23/02; G06T 5/80; G06T 7/55

(52) U.S. Cl. CPC F41G 3/06; F41G 3/08; G02B 23/02; G06T 5/80; G06T 7/55

(57) ABSTRACT

Aiming devices are provided. A first image is displayed at a first position of a display unit, wherein the first image faces an image side of an imaging system and is reflected by the image side and then moves along an optical axis, and a first imaging pattern is formed on an imaging surface of the imaging system corresponding to the first position. An adjustment unit can move the first image in the display unit to a second position to form a second image, such that a second imaging pattern is formed at the imaging surface corresponding to the second position. When the second image is different from the first image, the processing unit makes the first imaging pattern and the second imaging pattern still the same. When the second image is asymmetric, the second imaging pattern still maintains symmetric.

### BACKGROUND OF THE INVENTION

### Field of the Invention

The disclosure relates generally to aiming devices, and more particularly to aiming devices and methods for correcting deformations in imaging patterns in the aiming devices.

### Description of the Related Art

In the use of shooting devices such as crossbows and firearms, calculating ballistic compensation at different distances has a significant impact on shooting accuracy. Generally, shooting devices are used in conjunction with aiming devices to increase aiming accuracy. Generally, regardless of the light source or graphic used, due to lens design and limitations, when using spherical or aspherical lenses for reflected imaging, image deformation or uneven brightness often occurs at locations far from the axis of rotation. Typically, the greater the distance from the axis, the greater the image deformation, potentially leading to ghosting, blurring, or trailing. The same phenomenon occurs at different eye distances. This causes user confusion and may even lead to questions about the quality of the aiming and shooting devices themselves.

### BRIEF SUMMARY OF THE INVENTION

An embodiment of an aiming device comprises an imaging system, a display unit, an adjustment unit, and a processing unit. The imaging system comprises at least an optical mirror unit, wherein an object-side surface of the optical mirror unit faces a target object, and an image-side surface of the optical mirror unit faces a display unit, wherein the object-side surface and the image-side surface define an optical axis and have an imaging surface. A first image is displayed at a first position on the display unit, wherein the first image at the first position faces the image side and is reflected by the image side and travels along the optical axis, thus to form a first imaging pattern on the imaging surface corresponding to the first position. The adjustment unit moves the first image in the display unit to a second position to form a second image, wherein the second image at the second position faces the image side and is reflected by the image side and travels along the optical axis, thus to form a second imaging pattern on the imaging surface corresponding to the second position. When the second image is different from the first image, the processing unit makes the first imaging pattern and the second imaging pattern still the same, that is, the ratio of the area of the first imaging pattern to the area of the imaging pattern is 0.9-1.1, or the ratio of the brightness of the first imaging pattern to the brightness of the second imaging pattern is 0.9-1.1, or the overlap of the shape of the first imaging pattern and the shape of the second imaging pattern is 0.9-1.1; or when the second image is asymmetric, the second imaging pattern still maintains symmetric.

An embodiment of an aiming device comprises an imaging system, a display unit, an adjustment unit, and a processing unit. The imaging system comprises at least an objective lens unit facing a target object, and an eyepiece unit, wherein the objective lens unit and the eyepiece unit define an optical axis and have an imaging surface. The display unit displays a first image at a first position on the display unit, wherein the first image at the first position passes through the imaging system and along the optical axis through at least one optical component, and forms a first imaging pattern on the imaging surface corresponding to the first position. The adjustment unit moves the first image in the display unit to a second position to form a second image, wherein the second image at the second position passes through the imaging system and along the optical axis through the at least one optical component, and forms a second imaging pattern on the imaging surface corresponding to the second position. When the second image is different from the first image, the processing unit makes the first imaging pattern and the second imaging pattern still the same, that is, the ratio of the area of the first imaging pattern to the area of the imaging pattern is 0.9-1.1, or the ratio of the brightness of the first imaging pattern to the brightness of the second imaging pattern is 0.9-1.1, or the overlap of the shape of the first imaging pattern and the shape of the second imaging pattern is 0.9-1.1; or when the second image is asymmetric, the second imaging pattern still maintains symmetric.

An embodiment of an aiming device comprises an imaging system, and a light-emitting unit. The imaging system comprises at least an optical mirror unit, wherein an object-side surface of the optical mirror unit faces a target object, an image-side surface of the optical mirror unit faces the light-emitting unit, and the object-side surface and the image-side surface define an optical axis and have an imaging surface. The light-emitting unit contains a first image, wherein the first image faces the image-side surface and is reflected by the image-side surface and travels along the optical axis, thus to form a first imaging pattern on the imaging surface. The shape of the first image is different from the shape of the first imaging, and the shape of the first image is asymmetrical while the shape of the first imaging is symmetrical.

In an embodiment of a method of image correction for use in an aiming device, a first image is displayed at a first position on a display unit of the aiming device, wherein the first image passes through an imaging system of the aiming device, thus to form a first imaging pattern on an imaging surface corresponding to the first position. The first image in the display unit is moved to a second position at a second position to form a second image, wherein the second image passes through the imaging system, thus to form a second imaging pattern on the imaging surface corresponding to the second position. It is determined whether the second image is different from the first image. When the second image is different from the first image, the first imaging pattern and the second imaging pattern are made still the same, that is, the ratio of the area of the first imaging pattern to the area of the imaging pattern is 0.9-1.1, or the ratio of the brightness of the first imaging pattern to the brightness of the second imaging pattern is 0.9-1.1, or the overlap of the shape of the first imaging pattern and the shape of the second imaging pattern is 0.9-1.1; or when the second image is asymmetric, the second imaging pattern still maintains symmetric.

In some embodiments, the processing unit further performs an image correction method, wherein the method comprises the steps of providing at least one deformed imaging coordinate, displaying the first image using the display unit, moving the first image in the display unit to a specific coordinate corresponding to the second position according to the control of the adjustment unit, determining whether the specific coordinate belongs to the deformed imaging coordinate, and when the specific coordinate of the second position belongs to the deformed imaging coordinate, performing a correction operation on the second image to correct the shape, area, or brightness of the second image, such that the ratio of the area of the first imaging pattern to the area of the second imaging pattern is 0.9 to 1.1, or the ratio of the brightness of the first imaging pattern to the brightness of the second imaging pattern is 0.9 to 1.1, or the overlap between the shape of the first imaging pattern and the shape of the second imaging pattern is 0.9 to 1.1; or correcting the second image to an asymmetric image.

In some embodiments, the image correction method comprises the steps of calculating a distance and an angle based on a starting coordinate in the display unit before the first image moves and the specific coordinate after the movement, and performing the correction operation on the second image based on the distance, the angle, and the first image.

In some embodiments, a method for generating the deformed imaging coordinate in the image correction method comprises the steps of displaying the first image at an axial center position of the display unit, and acquiring the first imaging pattern corresponding to the first image via an image capturing unit through an optical path, wherein the axial center position is an initial coordinate, moving the first image in the display unit to a target coordinate, and acquiring a second imaging pattern corresponding to the second image located at the target coordinate via the optical path using the image capturing unit, calculating a distance or an angle based on the initial coordinate and the target coordinate, and determining whether the distance or the angle exceeds a preset distance or a preset angle, and when the distance or the angle exceeds the preset distance or the preset angle, setting the target coordinate as the deformed imaging coordinate.

In some embodiments, the image correction method further comprises automatically moving the first image in the display unit through software control to repeatedly perform the steps of acquiring the second image or calculating the distance or angle, determining whether the second imaging pattern is deformed or exceeds the preset distance or preset angle, and setting the coordinates of the deformed image.

In some embodiments, a method for generating the deformed imaging coordinate in the image correction method comprises the steps of displaying the first image at an axial center position of the display units, and acquiring the first imaging pattern corresponding to the first image via an image capturing unit through an optical path, wherein the axial center position is an initial coordinate, moving the first image in the display unit to a target coordinate, and acquiring a second imaging pattern corresponding to the second image located at the target coordinate via the optical path using the image capturing unit, determining whether the second imaging pattern is deformed based on the first imaging pattern and the second imaging pattern, and setting the target coordinate as the deformed image coordinate when the second imaging pattern is deformed.

In some embodiments, the imaging system comprises an inner red dot sight or a telescope sight.

In some embodiments, the adjustment unit comprises a trajectory adjustment unit or a windage adjustment unit.

Image correction methods for use in an aiming device may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an aiming device of the invention;

FIG. 2 is a schematic diagram illustrating another embodiment of an aiming device of the invention;

FIG. 3 is a schematic diagram illustrating an embodiment of a shooting device and an aiming device of the invention;

FIG. 4 is a flowchart of an embodiment of an image correction method for an aiming device of the invention;

FIG. 5 is a flowchart of an embodiment of a method for generating deformed imaging coordinates of the invention;

FIG. 6 is a schematic diagram illustrating image deformation examples for different deformed imaging coordinates;

FIG. 7 is a flowchart of another embodiment of an image correction method for an aiming device of the invention;

FIG. 8 is a schematic diagram illustrating an embodiment of an example of image deformation of the invention;

FIG. 9 is a schematic diagram illustrating an embodiment of an example of image correction of the invention;

FIG. 10 is a schematic diagram illustrating another embodiment of an example of image deformation of the invention;

FIG. 11 is a flowchart of another embodiment of a method for generating deformed imaging coordinates of the invention; and

FIG. 12 is a schematic diagram illustrating another embodiment of an example of image correction of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

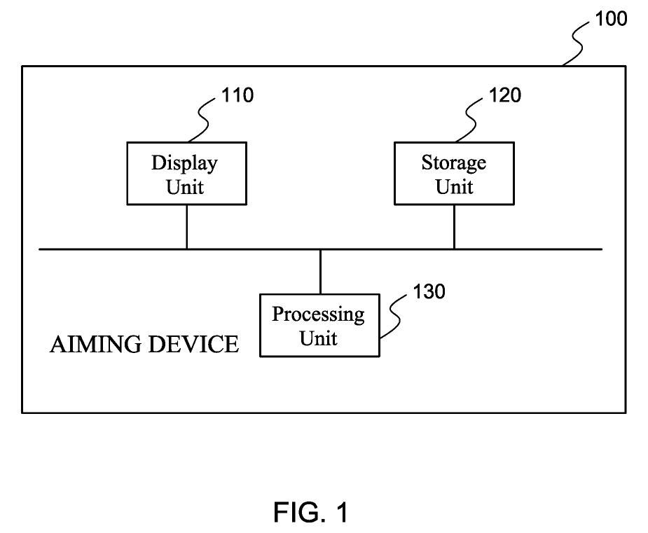

FIG. 1 is a schematic diagram illustrating an embodiment of an aiming device of the invention. The aiming device 100 according to an embodiment of the present invention includes at least a display unit 110, a storage unit 120, and a processing unit 130. The display unit 110 can be used to display relevant information, such as images and related interfaces or text. The storage unit 120 can be a memory used to store at least one deformed imaging coordinate. The method for generating the deformed imaging coordinate will be described later. The processing unit 130 can perform the image correction methods for an aiming device according to the deformed imaging coordinate, the details of which will be described later.

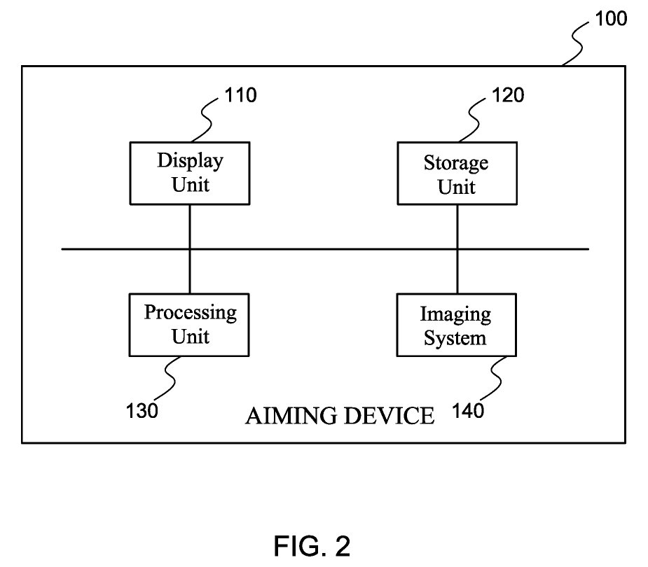

FIG. 2 is a schematic diagram illustrating another embodiment of an aiming device of the invention. The aiming device 100 according to an embodiment of the present invention includes at least a display unit 110, a storage unit 120, a processing unit 130, and an imaging system 140. The display unit 110 can be used to display relevant information, such as images and related interfaces or text. The storage unit 120 can be a memory used to store at least one deformed imaging coordinate. The method for generating the deformed imaging coordinate will be described later. The processing unit bcan perform the image correction method for an aiming device according to the deformed imaging coordinate, the details of which will be described later.

A specific image or object can pass through the imaging system 140 to obtain an imaging pattern. In some embodiments, the imaging system 140 may be a red dot sight or a telescope sight. In some embodiments, the imaging system 140 may include an image capturing unit. In this embodiment, the imaging system 140 includes at least one optical mirror unit, an object side of which faces the target, and an image side of which faces the display unit 110. The object side and the image side define an optical axis and have an imaging surface. The image displayed by the display unit 110 faces the image side and is reflected by the image side, then travels along the optical axis and forms an image pattern on the imaging surface. In some embodiments, the imaging system 140 may include an objective lens unit, and/or an upright lens group and an eyepiece unit, which define a telescopic optical path and have an imaging surface. The image displayed by the display unit can pass through the imaging system 140 and along the optical axis through at least one optical component and form an imaging pattern on the imaging surface. Note that in some embodiments, the optical path of the display unit may be reflected and folded into the telescopic optical path. In some embodiments, the display unit may be a transmissive display. In other words, the optical path of the display unit may be located within the telescope's optical path.

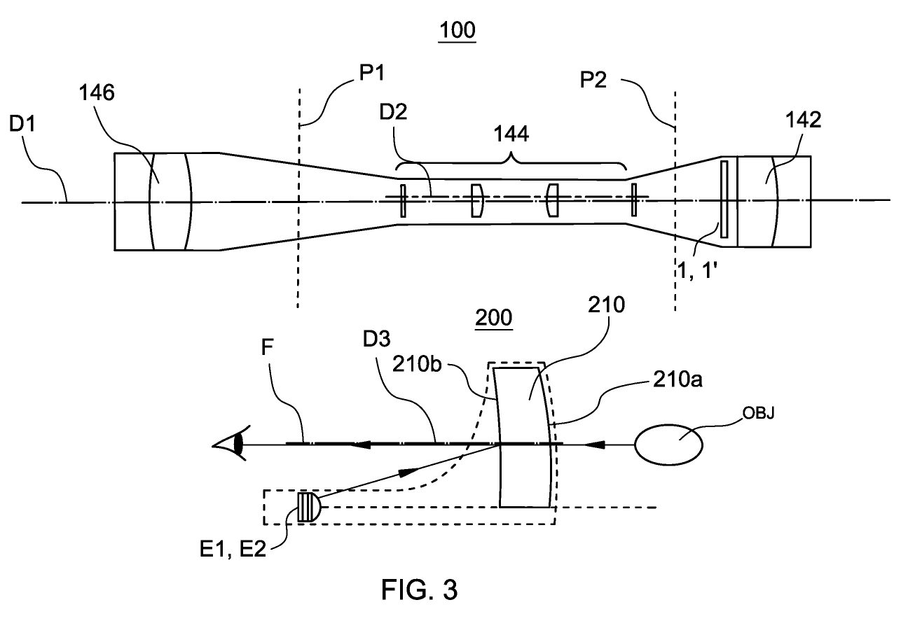

It is understood that, in some embodiments, the aiming device 100 can be detachably fixed to a shooting device, such as a pistol or crossbow. For example, FIG. 3 shows an aiming device according to an embodiment of the invention. As shown in FIG. 3, the aiming device of the invention can be, for example, a sight with telescope function (shown in the upper view of FIG. 3) or a red dot sight (shown in the lower view of FIG. 3). This structure can be used for both sights with telescope function and red dot sights. Specifically, the aiming device 100 with telescope function includes an eyepiece unit 142, an intermediate lens group unit 144, and an objective lens unit 146. The intermediate lens group unit 144 is disposed between the eyepiece unit 142 and the objective lens unit 146. The eyepiece unit 142 and the objective lens unit 146 jointly define a first optical axis D1. The objective lens unit 146 has a first imaging plane P1 (i.e., the focal length position of the entire objective lens unit 146). The intermediate lens group unit 144 has a second optical axis D2 and a second imaging plane P2 (i.e., the focal length position of the entire intermediate lens group unit 144). The intermediate lens unit 144 can be an upright lens group, which forms an upright imaging pattern for an inverted imaging pattern corresponding to a distant object through the objective lens unit 146. The user views the upright image of the distant object through the eyepiece unit 142. It also includes an adjustment unit (not shown), which is set perpendicular to the first optical axis D1 and connected to the intermediate lens unit 144. When the adjustment unit moves to adjust the intermediate lens unit 144, the second optical axis D2 can be moved to adjust so that the second optical axis D2 is parallel to the first optical axis D1 or forms an angle with it. The pattern structures 1 and 1' of the invention are disposed on the first imaging surface P1 or the second imaging surface P2, that is, the first light source unit (not shown) and the second light source unit (not shown) are disposed on the first imaging surface P1 or the second imaging surface P2. The first light source unit and the second light source unit respectively generate a light beam, which is directed toward the eyepiece unit 142 and propagates along the first optical axis D1, so that the user can view the pattern structures 1 and 1' through the eyepiece unit 142. The intermediate lens group unit 144 may have optical zoom features. The adjustment unit is a trajectory adjustment unit or a windage adjustment unit.

The red dot sight 200 is relatively simple compared to sights with telescope functionality. Specifically, the red dot sight 200 includes an objective lens unit 210, which includes an object-side side 210a and an image-side side 210b. The object-side side 210a faces the target object OBJ, while the image-side side 210b faces the user. The object-side side 210a and the image-side side 210b define the optical axis D3. The objective lens unit 210 has a focal point F, where pattern structures 1 and 1' are located. That is, the first light source unit E1 and the second light source unit E2 are located at the focal point F, and the focal point F is located on one side of the image-side side 210b. The first light source unit E1 and the second light source unit E2 each generate a light beam. These light beams are directed toward the pair of objective lens units 210 and, after being reflected by the objective lens units 210, travel along the optical axis D3 so that the user can view the pattern structure.

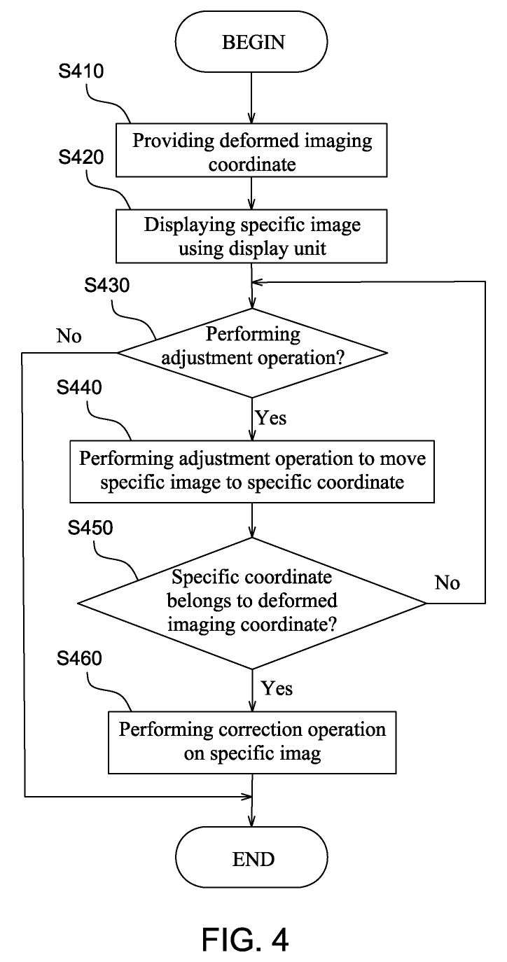

FIG. 4 is a flowchart of an embodiment of an image correction method for an aiming device of the invention. The image correction method for an aiming device according to the embodiments of the invention is applicable to the aiming device shown in FIGS. 1 or 2.

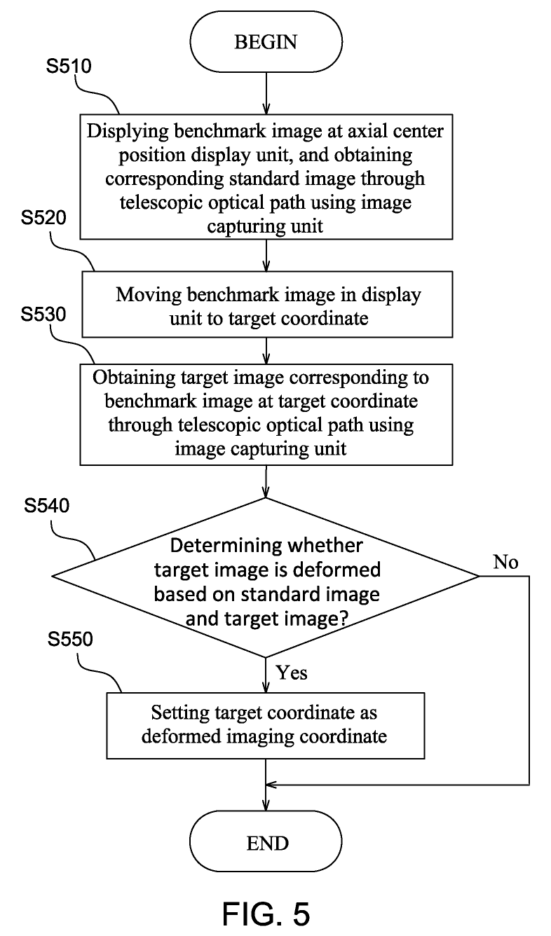

First, in step S410, at least one deformed imaging coordinate is provided. It should be noted that the deformed imaging coordinate can be recorded in the storage unit of the aiming device, such as in memory. FIG. 5 shows a method for generating deformed imaging coordinates according to an embodiment of the present invention. First, in step S510, a benchmark image (first image) is displayed at the axial center position of the display unit, and a standard image (first imaging pattern) corresponding to the benchmark image (first image) is obtained through the telescopic optical path using an image capturing unit. It is worth noting that in some embodiments, the telescopic optical path can pass through at least one optical component, such as the objective lens unit, upright lens group, and eyepiece unit of a telescopic sight. In some embodiments, the telescopic optical path can be reflected by at least one optical component, such as an inner red dot sight. Then, in step S520, the benchmark image (first image) in the display unit is moved to a target coordinate. Note that, for ease of understanding, the image located at the target coordinate can be referred to as a second image, and in step S530, a target image (second imaging pattern) corresponding to the benchmark image located at the target coordinate is obtained through the telescopic optical path using an image capturing unit. Next, in step S540, based on the standard image (first imaging pattern) and the target image (second imaging pattern), it is determined whether the target image (second imaging pattern) is deformed compared to the standard image (first imaging pattern). If the target image (second imaging pattern) is not deformed (No in step S540), the process ends. If the target image (second imaging pattern) is deformed (Yes in step S540), in step S550, the target coordinate are set as a deformed imaging coordinate. It is worth noting that in some embodiments, the benchmark image in the display unit can be automatically moved by software control to repeatedly perform the aforementioned steps S520 to S550 of moving the benchmark image, acquiring the target image, determining whether the target image is deformed, and setting the deformed imaging coordinates. In some embodiments, the aforementioned movement of the benchmark image can be repeated until it has moved to all pixels (coordinates) in the display unit.

In some embodiments, the method for generating deformed imaging coordinates can be performed by displaying a benchmark image (first image) at the axial center position of the display unit, and using an image capturing unit to obtain a standard image (first imaging pattern) corresponding to the benchmark image (first image) via a telescopic optical path. The axial center position is the initial coordinate. Then, the benchmark image (first image) in the display unit is moved to a target coordinate. Note that, for ease of understanding, the image located at the target coordinate can be referred to as a second image. The image capturing unit uses a telescopic optical path to obtain a target image (second imaging pattern) corresponding to the target coordinate. Then, based on the initial coordinate and the target coordinate, a distance or an angle is calculated to determine whether the distance or angle exceeds a preset distance or preset angle. When the preset distance or preset angle is exceeded, the target coordinate is set as a deformed imaging coordinate.

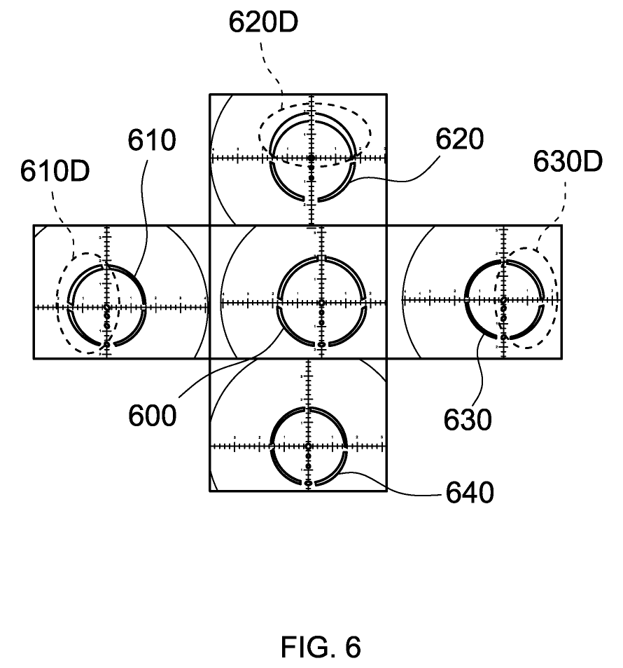

For example, FIG. 6 shows examples of image deformation corresponding to different deformed imaging coordinates. Initially, a benchmark image (first image) can be displayed at the center position of the display unit, and a standard image 600 (first imaging pattern) corresponding to the benchmark image is obtained through the telescopic optical path by the image capturing unit. When the benchmark image in the display unit is moved to the left, top, right, and bottom coordinates of the center position, respectively, the image capturing unit can capture target images (second imaging pattern) 610, 620, 630, and 640, respectively. After comparing the target images (second imaging patterns) 610, 620, 630, and 640 with the standard image (first imaging pattern) 600, it can be found that the left side 610D of the target image 610 is deformed, the top side 620D of the target image 620 is deformed (i.e., asymmetrical), and the right side 630D of the target image 630 is deformed. Therefore, the left, top, and right coordinates of the corresponding center positions are recorded as deformed imaging coordinates. It should be noted that, after the benchmark image has moved to all coordinate positions, all coordinates of imaging deformation can be obtained, and these coordinates are all stored in the memory device. It should also be noted that in some embodiments, the differences, such as area, shape, and/or brightness between the target image (second imaging pattern) at the corresponding deformed imaging coordinate positions and the standard image (first imaging pattern) can also be recorded simultaneously.

Then, in step S420, a specific image is displayed by the display unit. In step S430, it is determined whether an adjustment operation is performed. It is worth noting that in some embodiments, the adjustment operation can be used for trajectory adjustment or windage adjustment. It must be noted that the aforementioned adjustment operation is merely an example of this invention, and the invention is not limited thereto. Any adjustment operation that moves the position of the image displayed in the display unit is applicable to this invention. When no adjustment operation is performed (No in step S430), the process ends. When an adjustment operation is performed (Yes in step S440), in step S440, the adjustment operation is performed to move the specific image in the display unit to a specific coordinate. In step S450, it is determined whether the specific coordinate belongs to the deformed imaging coordinates recorded in the storage unit. When the specific coordinate does not belong to the deformed imaging coordinates (No in step S450), the process returns to step S430. When the specific coordinate belongs to the deformed imaging coordinates (Yes in step S450), in step S460, a correction operation is performed on the specific image. It is worth noting that, in some embodiments, an imaging pattern corresponding to the specific image after the correction operation can be obtained through the imaging system via the telescope optical path for display.

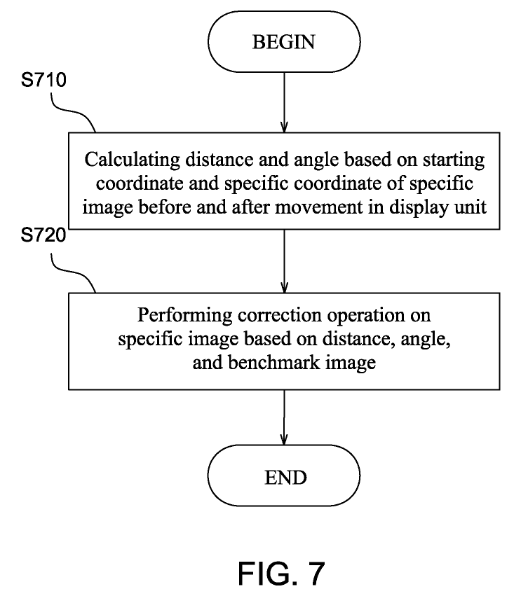

FIG. 7 is a flowchart of another embodiment of an image correction method for an aiming device of the invention. First, in step S710, a distance and an angle are calculated based on a starting coordinate of the specific image and a specific coordinate of the specific image after the movement in the display unit. Then, in step S720, a correction operation is performed on the specific image based on the distance, the angle, and the benchmark image. It is worth noting that in some embodiments, the correction operation can correct the shape, area, and/or brightness of the specific image.

As described, the correction operation can be performed on the specific image.

In some embodiments, the ratio of the imaging area before and after the correction operation is 0.9 to 1.1, or the ratio of the imaging brightness before and after the correction operation is 0.9 to 1.1, or the overlap of the imaging shape before and after the correction operation is 0.9 to 1.1; or the imaging after the correction operation is corrected to a symmetrical image.

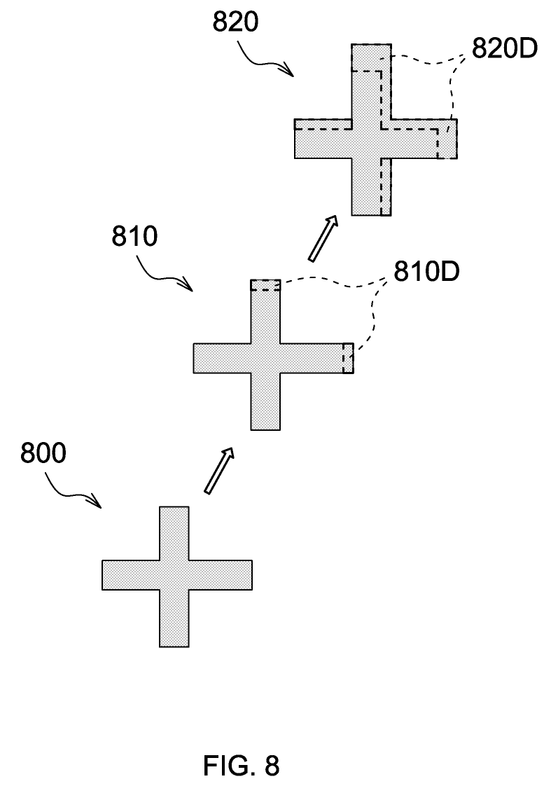

It is understood that, during image movement, the distance and the angle from the original center position after each coordinate shift can cause varying degrees of distortion in the image. For example, the center of the display unit can display a specific image (first image), and its imaging pattern can be the standard image 800 (first imaging pattern) shown in FIG. 8. When the specific image (first image) moves to the upper right, a deformation 810D (i.e., asymmetry) will occur in the corresponding target image (second imaging pattern) 810. When the specific image moves further to the upper right, even more deformation 820D (i.e., asymmetry) will occur in the corresponding target image (second imaging pattern) 820. Therefore, in image correction, calculations can be performed based on the respective specific coordinates and the starting coordinate to obtain the respective distances and angles between the respective specific coordinates and the starting coordinate, and different degrees of correction can be performed based on the respective distances and angles. As mentioned, in some embodiments, the differences, such as area, shape, and/or brightness between the target image (second imaging pattern) and the standard image (first imaging pattern) at the deformed imaging coordinate can also be recorded simultaneously. Image correction can also be performed based on pre-recorded data.

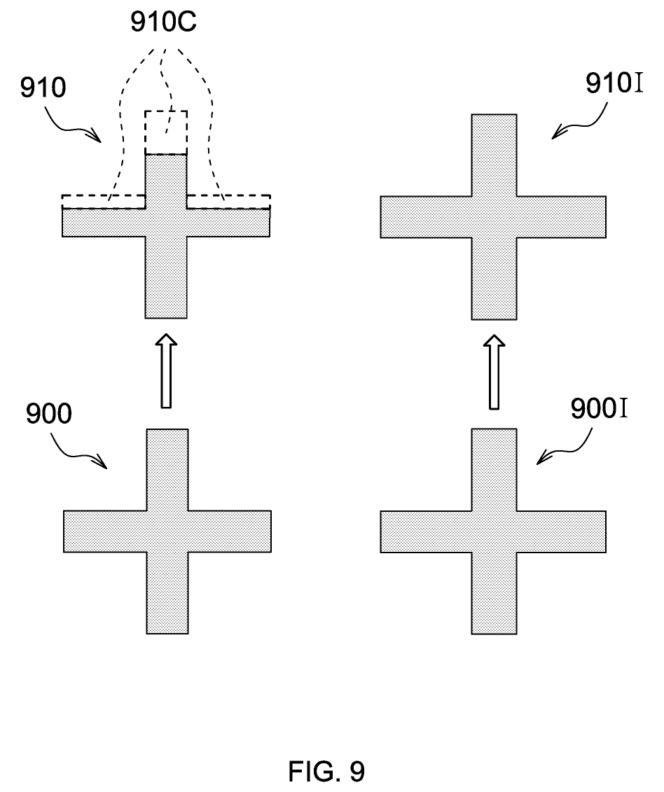

FIG. 9 is a schematic diagram illustrating an embodiment of an example of image correction of the invention.

In this example, the center position of the display unit can display a specific image 900, i.e., the first image at the first position of the display. The imaging pattern obtained by the imaging system through the telescopic optical path is a standard image 900I, i.e., the first imaging pattern at the first position on the optical component. When the specific image 900 in the display unit is moved to the coordinate above its original position, and the coordinate above are the pre-recorded deformed imaging coordinates, the original specific image 900 is image-corrected to become a corrected specific image 910 (i.e., asymmetric), i.e., the second image at the second position of the display. During the image correction process, block 910C is deleted, so that the imaging pattern 910I formed by the imaging system to be symmetric, that is, the second imaging pattern at the second position on the optical component is the same as or equivalent to the original standard image 900I. When the area ratio, brightness ratio, or shape overlap of the specific image 900 and the corrected specific image 910 is less than 0.9 or greater than 1.1, that is they are not the same, a correction process is used to make the ratio of the imaging area of the standard image 900I before the correction process and the corrected imaging pattern 910I is 0.9 to 1.1 (meaning the same or equivalent), or the ratio of the imaging brightness before and after the correction operation is 0.9 to 1.1 (meaning the same or equivalent), or the overlap of the imaging shape before and after the correction operation is 0.9 to 1.1 (meaning the same or equivalent), or the imaging pattern after the correction operation (the imaging pattern 910I (second imaging pattern)) to be corrected to a symmetrical image, in which the corrected specific image 910 is an asymmetrical image.

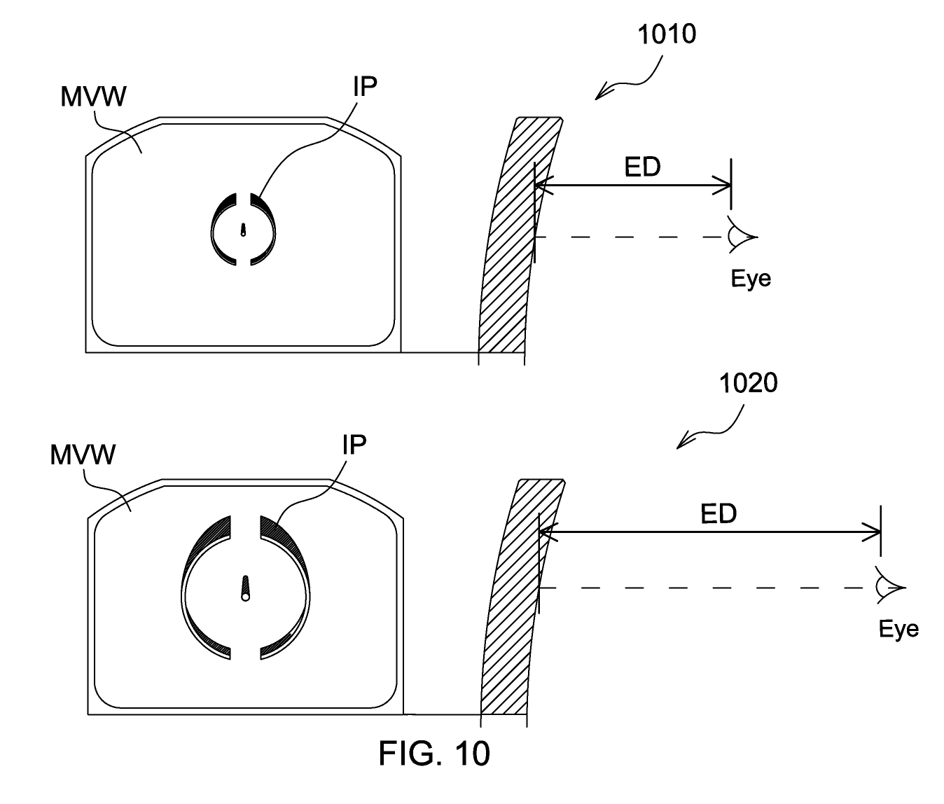

In some usage scenarios of the aiming device (especially the lower part of FIG. 3), because the aiming device in the lower part of FIG. 3 is not closed, different users will not be as close to their faces as the aiming device in the upper part of FIG. 3. Therefore, when a user is looking at the aiming device in the lower part of FIG. 3, they may sometimes be relatively close to or relatively far away from the aiming device, which means there will be different eye distances, thus changing the user's field of view (FOV) through the aiming device. Due to the design and limitations of the lenses inside the aiming device, the image generated by the pattern structure seen by the user at different eye distances will produce image deformation or uneven brightness at a distance farther off the axis, and will also change the relative occupancy of the main window and the image generated by the pattern structure (as shown in FIG. 10).

FIG. 10 is a schematic diagram illustrating another embodiment of an example of image deformation of the invention. As shown in FIG. 10, deformation occurs in both the upper and lower parts of the imaging pattern IP under both smaller and larger eye distances ED, with the amount of distortion increasing the further away from the axis. When the eye distance is adjusted from smaller to larger, the image of the structural pattern is displayed at a larger scale relative to the display unit as the FOV changes. That is, the relative occupancy of the image generated by the main view window MVW and the pattern structure decreases, where the occupancy is calculated by using the main view window MVW as the denominator and the size of the image generated by the pattern structure as the numerator. This makes image distortion or uneven brightness easier to observe.

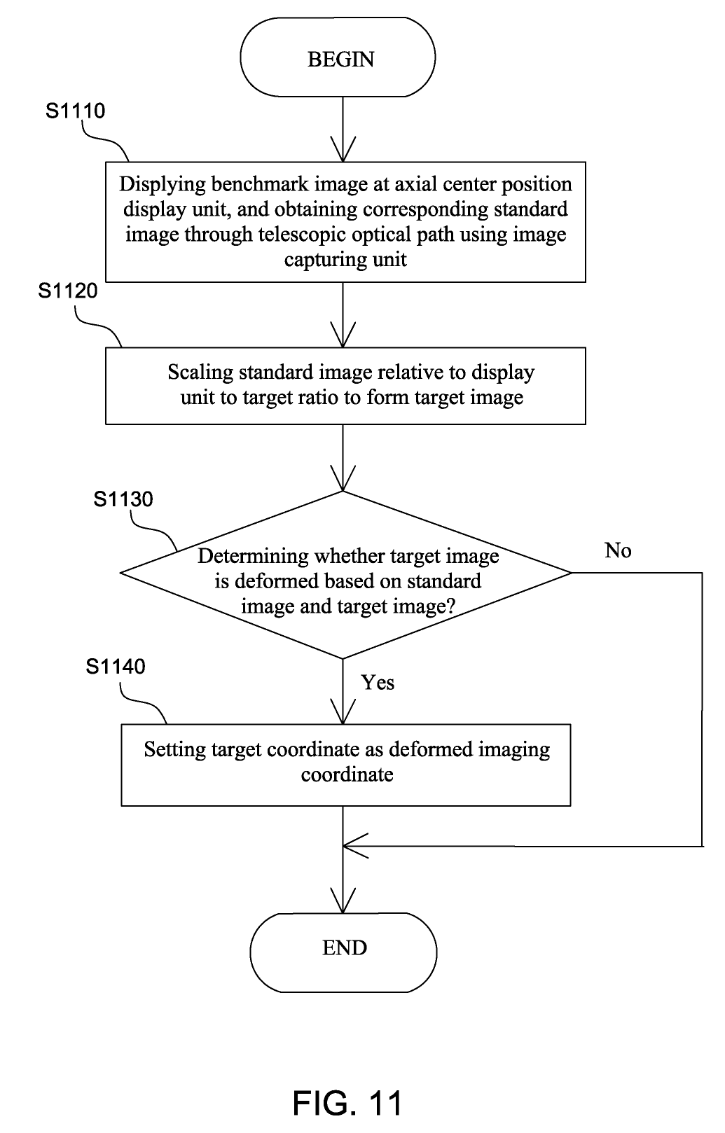

FIG. 11 is a flowchart of another embodiment of a method for generating deformed imaging coordinates of the invention. First, in step S1110, a benchmark image (first image) is displayed at the axial center position of the display unit, and a standard image (first imaging pattern) corresponding to the benchmark image (first image) is obtained by the image capturing unit through the telescopic optical path. Then, in step S1120, as the eye distance changes, the standard image is scaled relative to the display unit to a target ratio to form a target image (second imaging pattern). Then, in step S1130, based on the standard image (first imaging pattern) and the target image (second imaging pattern), it is determined whether the target image (second imaging pattern) is deformed compared to the standard image (first imaging pattern). That is, whether all parts of the target image are scaled proportionally compared to the standard image. If so, it is determined that no deformation has occurred. If parts of the target image are not scaled proportionally, but change in size, shape, or angle, it is determined that deformations has occurred. When the target image is deformed, its shape differs from that of the first image and the first imaging pattern. "Different" here means neither identical nor similar. For example, the first image and the first imaging pattern are symmetrical about the horizontal axis, while the first imaging pattern is asymmetrical about the horizontal axis.

When the target image (second imaging pattern) is not deformed (No in step S1130), the process ends. When the target image (second imaging pattern) is deformed (Yes in step S1130), in step S1140, the target coordinate of the target image scaled proportionally is set as the deformed imaging coordinate, that is, the image scaled proportionally is used as the second image. In some embodiments, the benchmark image in the display unit can be automatically moved by software control to repeatedly perform the steps of scaling the benchmark image, obtaining the target image, determining whether the target image is deformed, and setting the deformed imaging coordinates. In some embodiments, the aforementioned movement of the benchmark image can be repeated until it has moved to all pixels (coordinates) in the display unit.

In some embodiments, the deformed imaging coordinates generated in the embodiment of FIG. 11 can also be used in the embodiment of FIG. 4. As in step S410, at least one deformed imaging coordinate is provided. In step S420, a specific image is displayed using the display unit. In step S430, it is determined whether an adjustment operation is performed. If no adjustment operation is performed (No in step S430), the process ends. If an adjustment operation is performed (Yes in step S440), in step S440, the adjustment operation is performed to move the specific image in the display unit to a specific coordinate. In step S450, it is determined whether the specific coordinate belongs to the deformed imaging coordinates recorded in the storage unit. If the specific coordinate does not belong to the deformed imaging coordinates (No in step S450), the process returns to step S430. If the specific coordinate belongs to the deformed imaging coordinates (Yes in step S450), in step S460, a correction operation is performed on the specific image. It is worth noting that in some embodiments, the imaging pattern of the corresponding corrected specific image can be obtained through the imaging system via the telescope optical path for display.

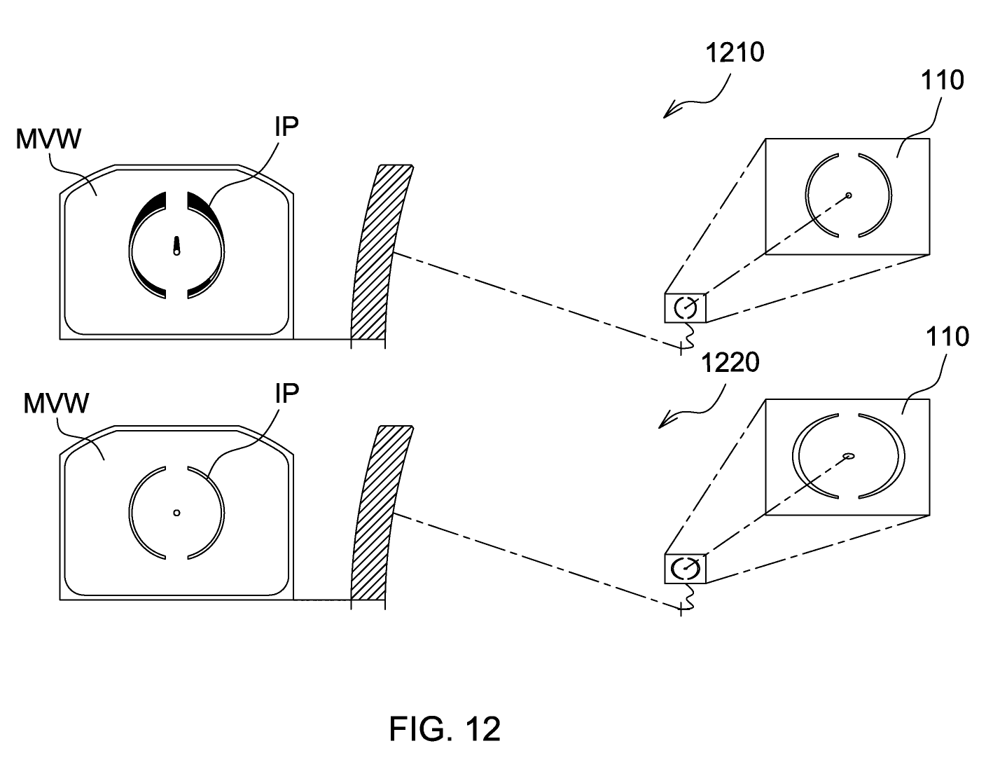

FIG. 12 is a schematic diagram illustrating another embodiment of an example of image correction of the invention. In this embodiment, unlike FIG. 11 where the target image is scaled proportionally and its coordinates are set as the deformed imaging coordinates, in FIG. 12, this embodiment corrects the deformed target image (second imaging pattern IP) by changing the benchmark image (first image) displayed at the axial center position of the display unit 110 at the same eye distance (assumed to be a first eye distance). After the first eye distance is corrected, correction is then performed for the second eye distance. Specifically, when it is determined that the target image (second imaging pattern) is deformed, the size, shape, or angle that needs to be compensated is calculated and fed back to the first light source unit and/or the second light source unit forming the pattern, which can correspond to the first pixel and/or the second pixel of the display unit 110. This results in different pattern structures formed by the light beams emitted by the corresponding first light source unit and/or second light source unit, thereby correcting the deformed target image (second imaging pattern). Specifically, when the target image (second imaging pattern) is deformed by increasing its external size and thickening its outline in the vertical direction, the first pattern formed by the beam emitted by the corresponding first light source unit and/or second light source unit can be made by increasing its size and thickening its outline in the horizontal direction, so as to correct the deformed target image (second imaging pattern) and ensure that the outline of the target image (second imaging pattern) does not deform in the vertical, horizontal, left and right directions. The upper part 1210 of FIG. 12 shows the case where no image correction has been performed, while the lower part 1220 of FIG. 12 shows the case where image correction has been performed.

Therefore, the aiming device and methods of the present invention can correct deformations in the image captured by the aiming device. Once an adjustment operation is performed to move the image to the coordinates where deformation begins, automatic corrections can be performed through procedural calculations. This invention can use a display as a light source and apply software to automatically adjust the illuminated pattern or brightness to correct deformed images. Using a display as a light source not only allows for unrestricted switching of pattern styles but also enables flexible utilization of this technology to correct defective optical qualities, something currently unattainable with light-emitting units such as LEDs (light-emitting diodes) and RCLEDs (Resonant Cavity Light Emitting Diodes). Through the aiming devices and methods of this invention, the dimensions requiring compensation can be obtained through the display and then fed back to the graphic size design of the light-emitting unit (e.g., RCLED, but not limited to). Although the modified RCLED's graphic size can no longer be automatically corrected using procedural calculations (pixel/picture + element fine-tuning), the RCLED's graphic size is already a compensated size, thus it is suitable for different eye distances and corresponding optical designs. It must be noted that the specific image mentioned in this application refers to any pattern in the display unit whose position can be moved by the adjustment unit. Images in the display unit that cannot be moved, such as but not limited to power levels, angle values, adjustment values, or other patterns, will not be affected by the correction operation in this case. In other words, even if these immovable images are adjusted and changed, such as when their values change, their position does not move, therefore they are not the images involved in the invention.

Image correction methods for use in an aiming device may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. An aiming device, comprising:
an imaging system comprises at least an optical mirror unit, wherein an object-side surface of the optical mirror unit faces a target object, and an image-side surface of the optical mirror unit faces a display unit, wherein the object-side surface and the image-side surface define an optical axis and have an imaging surface;
the display unit, wherein a first image is displayed at a first position on the display unit, wherein the first image at the first position faces the image side and is reflected by the image side and travels along the optical axis, thus to form a first imaging pattern on the imaging surface corresponding to the first position;
an adjustment unit moving the first image in the display unit to a second position to form a second image, wherein the second image at the second position faces the image side and is reflected by the image side and travels along the optical axis, thus to form a second imaging pattern on the imaging surface corresponding to the second position; and
a processing unit, when the second image is different from the first image, making the first imaging pattern and the second imaging pattern still the same, that is, the ratio of the area of the first imaging pattern to the area of the imaging pattern is 0.9-1.1, or the ratio of the brightness of the first imaging pattern to the brightness of the second imaging pattern is 0.9-1.1, or the overlap of the shape of the first imaging pattern and the shape of the second imaging pattern is 0.9-1.1; or when the second image is asymmetric, the second imaging pattern still maintains symmetric.

2. The device as claimed in claim 1, wherein the processing unit further performs an image correction method, wherein the method comprises the steps of:
providing at least one deformed imaging coordinate;
displaying the first image using the display unit;
moving the first image in the display unit to a specific coordinate corresponding to the second position according to the control of the adjustment unit;
determining whether the specific coordinate belongs to the deformed imaging coordinate; and
when the specific coordinate of the second position belongs to the deformed imaging coordinate, performing a correction operation on the second image to correct the shape, area, or brightness of the second image, such that the ratio of the area of the first imaging pattern to the area of the second imaging pattern is 0.9 to 1.1, or the ratio of the brightness of the first imaging pattern to the brightness of the second imaging pattern is 0.9 to 1.1, or the overlap between the shape of the first imaging pattern and the shape of the second imaging pattern is 0.9 to 1.1; or correcting the second image to an asymmetric image.

3. The device as claimed in claim 2, wherein the image correction method further comprises the steps of:
calculating a distance and an angle based on a starting coordinate in the display unit before the first image moves and the specific coordinate after the movement; and
performing the correction operation on the second image based on the distance, the angle, and the first image.

4. The device as claimed in claim 2, wherein a method for generating the deformed imaging coordinate in the image correction method comprises the steps of:
displaying the first image at an axial center position of the display unit, and acquiring the first imaging pattern corresponding to the first image via an image capturing unit through an optical path, wherein the axial center position is an initial coordinate;
moving the first image in the display unit to a target coordinate, and acquiring a second imaging pattern corresponding to the second image located at the target coordinate via the optical path using the image capturing unit;
calculating a distance or an angle based on the initial coordinate and the target coordinate, and determining whether the distance or the angle exceeds a preset distance or a preset angle; and
when the distance or the angle exceeds the preset distance or the preset angle, setting the target coordinate as the deformed imaging coordinate.

5. The device as claimed in claim 4, wherein the image correction method further comprises automatically moving the first image in the display unit through software control to repeatedly perform the steps of acquiring the second image or calculating the distance or angle, determining whether the second imaging pattern is deformed or exceeds the preset distance or preset angle, and setting the coordinates of the deformed image.

6. The device as claimed in claim 2, wherein a method for generating the deformed imaging coordinate in the image correction method comprises the steps of:
displaying the first image at an axial center position of the display units, and acquiring the first imaging pattern corresponding to the first image via an image capturing unit through an optical path, wherein the axial center position is an initial coordinate;
moving the first image in the display unit to a target coordinate, and acquiring a second imaging pattern corresponding to the second image located at the target coordinate via the optical path using the image capturing unit;
determining whether the second imaging pattern is deformed based on the first imaging pattern and the second imaging pattern; and
setting the target coordinate as the deformed image coordinate when the second imaging pattern is deformed.

7. The device as claimed in claim 1, wherein the imaging system comprises an inner red dot sight or a telescope sight.

8. The device as claimed in claim 1, wherein the adjustment unit comprises a trajectory adjustment unit or a windage adjustment unit.

9. An aiming device, comprising:
an imaging system comprises at least an objective lens unit facing a target object, and an eyepiece unit, wherein the objective lens unit and the eyepiece unit define an optical axis and have an imaging surface;
a display unit displaying a first image at a first position on the display unit, wherein the first image at the first position passes through the imaging system and along the optical axis through at least one optical component, and forms a first imaging pattern on the imaging surface corresponding to the first position;
an adjustment unit moving the first image in the display unit to a second position to form a second image, wherein the second image at the second position passes through the imaging system and along the optical axis through the at least one optical component, and forms a second imaging pattern on the imaging surface corresponding to the second position; and
a processing unit, when the second image is different from the first image, making the first imaging pattern and the second imaging pattern still the same, that is, the ratio of the area of the first imaging pattern to the area of the imaging pattern is 0.9-1.1, or the ratio of the brightness of the first imaging pattern to the brightness of the second imaging pattern is 0.9-1.1, or the overlap of the shape of the first imaging pattern and the shape of the second imaging pattern is 0.9-1.1; or when the second image is asymmetric, the second imaging pattern still maintains symmetric.

10. The device as claimed in claim 9, wherein the processing unit further performs an image correction method, wherein the method comprises the steps of:
providing at least one deformed imaging coordinate;
displaying the first image using the display unit;
moving the first image in the display unit to a specific coordinate corresponding to the second position according to the control of the adjustment unit;
determining whether the specific coordinate belongs to the deformed imaging coordinate; and
when the specific coordinate of the second position belongs to the deformed imaging coordinate, performing a correction operation on the second image to correct the shape, area, or brightness of the second image, such that the ratio of the area of the first imaging pattern to the area of the second imaging pattern is 0.9 to 1.1, or the ratio of the brightness of the first imaging pattern to the brightness of the second imaging pattern is 0.9 to 1.1, or the overlap between the shape of the first imaging pattern and the shape of the second imaging pattern is 0.9 to 1.1; or correcting the second image to an asymmetric image.

11. The device as claimed in claim 10, wherein the image correction method further comprises the steps of:
calculating a distance and an angle based on a starting coordinate in the display unit before the first image moves and the specific coordinate after the movement; and
performing the correction operation on the second image based on the distance, the angle, and the first image.

12. The device as claimed in claim 10, wherein a method for generating the deformed imaging coordinate in the image correction method comprises the steps of:
displaying the first image at an axial center position of the display unit, and acquiring the first imaging pattern corresponding to the first image via an image capturing unit through an optical path, wherein the axial center position is an initial coordinate;
moving the first image in the display unit to a target coordinate, and acquiring a second imaging pattern corresponding to the second image located at the target coordinate via the optical path using the image capturing unit;
calculating a distance or an angle based on the initial coordinate and the target coordinate, and determining whether the distance or the angle exceeds a preset distance or a preset angle; and
when the distance or the angle exceeds the preset distance or the preset angle, setting the target coordinate as the deformed imaging coordinate.

13. The device as claimed in claim 10, wherein a method for generating the deformed imaging coordinate in the image correction method comprises the steps of:
displaying the first image at an axial center position of the display units, and acquiring the first imaging pattern corresponding to the first image via an image capturing unit through an optical path, wherein the axial center position is an initial coordinate;
moving the first image in the display unit to a target coordinate, and acquiring a second imaging pattern corresponding to the second image located at the target coordinate via the optical path using the image capturing unit;
determining whether the second imaging pattern is deformed based on the first imaging pattern and the second imaging pattern; and
setting the target coordinate as the deformed image coordinate when the second imaging pattern is deformed.

14. The device as claimed in claim 13, wherein the image correction method further comprises automatically moving the first image in the display unit through software control to repeatedly perform the steps of acquiring the second image or calculating the distance or angle, determining whether the second imaging pattern is deformed or exceeds the preset distance or preset angle, and setting the coordinates of the deformed image.

15. The device as claimed in claim 9, wherein the imaging system comprises an inner red dot sight or a telescope sight.

16. The device as claimed in claim 9, wherein the adjustment unit comprises a trajectory adjustment unit or a windage adjustment unit.

17. An aiming device, comprising:
a light-emitting unit; and
an imaging system comprising at least an optical mirror unit, an object-side surface of the optical mirror unit faces a target object, and an image-side surface of the optical mirror unit faces the light-emitting unit, wherein the object-side surface and the image-side surface define an optical axis and have an imaging surface,
wherein the light-emitting unit containing a first image, wherein the first image faces the image-side surface and is reflected by the image-side surface and travels along the optical axis, thus to form a first imaging pattern on the imaging surface,
wherein the shape of the first image is different from the shape of the first imaging, and the shape of the first image is asymmetrical while the shape of the first imaging is symmetrical.
